(19) United States
(12) Patent Application Publication
(10) Pub. No.: US 2006/0027182 A1
(43) Pub. Date: Feb. 9, 2006

(54) Method and apparatus for removing animal feed from storage bags

(76) Inventor: Richard W. Huth, Cameron, WI (US)

Correspondence Address: Richard C. Litman;LITMAN LAW OFFICES, LTD., P.O. Box 15035, Arlington, VA, 22215, US

(21) Appl. No.: 10/911,514

(22) Filed: Aug. 5, 2004

(51) Int. Cl. A01K 61/00

(52) U.S. Cl. 119/215

(57) ABSTRACT

The apparatus for removing animal feed from storage bags has a ramp, a bottom roller positioned behind the ramp, and a loading deck positioned behind the bottom roller. The apparatus also has a pivotally mounted scraper adjacent the bottom roller, auxiliary rollers disposed behind the scraper, two fences that run along the sides of the loading deck, and cutting blades for separating the different sections of the bag for collection on the rollers. The bottom roller includes cable-rolling portions for winding up anchored cables to move the apparatus forward. By connecting a bottom part of a storage bag to the bottom roller and by rotating the bottom roller, the animal feed is forced out of the bag and onto the loading deck for easy collection by a loader bucket, while the storage bag is rolled up on the rollers.

### BACKGROUND OF THE INVENTION

1. Field of the Invention

The present invention relates to a method and apparatus for removing or unloading animal feed, such as silage and the like, from an agricultural feed storage bag of the type formed of an elongated, tubular, flexible sheet of plastic material.

2. Description of the Related Art

Most cattle farmers feed their cattle silage. Silage is chopped hay or corn that is harvested while wet and then packed into an airtight space and allowed to ferment. Chopped hay is similar in consistency to grass lawn mower clippings.

Traditionally farmers have used vertical silos to store silage and other types of animal feed. Many farmers still use silos to store silage, but many large farms have switched to a bunker or pile type storage means, using a large sheet of plastic to keep rain and air out. The bunker or pile type storage is less expensive, but because the seal is insufficient it also results in an extra 15′ loss of silage from spoilage.

Over the past decade, elongated feed storage bags, which extend horizontally on the ground surface, have become a common replacement for the conventional vertical silos and bunker or pile type storage means. These huge bags are usually about 250 feet long, 10 feet in diameter, and about 8 mils thick. Several companies build and market machines that pack the chopped silage into these bags. The full bag is then left lying on the ground like a giant sausage. The use of such bags requires considerably less capital cost, and they are capable of storing large quantities of feed with little spoilage. Removing the feed from the bag, however, is usually more labor intensive than removing feed from an upright silo using a common unloader.

The conventional manner of unloading the bag involves scooping the animal feed from the open end of the bag with a loader bucket attached to a front end loader, skid-steer loader, or the like. Unloading the bag is a difficult process. It is difficult to get a full loader bucket because the bucket edge will not penetrate the fibrous material. Filling the loader bucket requires ample pushing up against the feed in the bag. This pushing and the frequent return trips cause the ground to become muddy. This mud further complicated the process of filling the loader bucket.

The bag itself further gets in the way of the unloading process. The square loader bucket will not reach into the round corners of the bag. It is difficult to load all of the feed without ripping the plastic between the feed and the ground. The plastic also needs to be cut away as the bag is unloaded. The plastic further needs to be pulled out of the mud and disposed of before it blows away.

U.S. Pat. No. 4,420,119, issued Dec. 13, 1983 to V. Johnson, describes a horizontal silage unloader for unloading silage from an elongated storage bag by discharging the contents of the bag, slitting the sides of the bag, rolling up the bag as it travels along the length of the bag towards a backstop member disposed against the closed end of the bag. Beater rods and conveyers are used to remove the silage from inside the bag before that section of the bag is cut and rolled up onto the rollers. Unloaders of this type are not widely available on a commercial basis. It is believed that attempts to market this machine have generally been unsuccessful due to the complexity of the proposed self-contained machine, which presents a cost problem, and due to the fact that this machine is not capable of dealing with variations in the size of the bags utilized and in the shapes assumed by such bags.

U.S. Pat. No. 6,109,552, issued Aug. 29, 2000 to D. Strankman, describes a feed bag unloading apparatus that includes a wheeled frame, a feed transfer means, and a lower roller means for collecting the bag after the feed is removed. The unloading apparatus employs a conveyor system for removing the silage from a trough member to an area of removal. The Strankman patent describes a machine that is better able to deal with variations in bag shape and sizes than the machine of the '119 patent, but still discloses a complex and expensive means of removing the silage from the bag before the bag is rolled up.

U.S. Pat. No. 5,839,676, issued Nov. 24, 1998 to W. Bevermann, discloses a cutting machine for extraction of silage from flat silos. The cutting machine swings an implement in a downward direction to remove and collect silage from a pile. Other patents showing similar devices include U.S. Patent Publication No. 2002/00076211, published Jan. 24, 2002; U.S. Pat. No. 6,505,786, issued Jan. 14, 2003 to N. Van Der Plas; German Patent No. 3,743,340, published Jun. 29, 1989; German Patent No. 3,807,228, published Sep. 14, 1989; German Patent No. 3,938,499, published Jun. 21, 1990; German Patent No. 3,936,415, published May 8, 1991; German Patent No. 19,707,979, published Dec. 17, 1998; and French Patent No. 2,773,433, published Jul. 15, 1999.

Various patents disclose other cutting means for removing silage from storage. U.S. Pat. No. 3,985,305, issued Oct. 12, 1976 to G. Williamson, discloses a silage unloader for silage stored in a silage trench. The silage unloader includes a silage cutting reel means rotatably mounted to remove silage from the trench. U.S. Pat. No. 4,195,786, issued Apr. 1, 1980 to A. Walker, discloses an apparatus for removing silage from a silo using a rotary hoe cutter. There have been various proposals of machines for removing the silage stored in silos, but removing silage from a feed storage bag presents different problems due to the presence of the plastic sheet material.

Other patents disclosing cutting means for removing silage include U.S. Pat. No. 4,336,732, issued Jun. 29, 1982 to F. Liet (device for cutting out and transporting a silage block); U.S. Pat. No. 4,367,855, issued Jan. 11, 1983 to H. von der Heide (apparatus for the excision and removal of blocks of silage); U.S. Pat. No. 5,003,684, issued Jul. 23, 1991 to H. von der Heide (silage cutting machine with U-shaped holding frame); European Patent No. 411,724, published Feb. 6, 1991 (device for cutting out and transporting a silage block); German Patent No. 3,940,634, published Jun. 13, 1991 (implement for removing silage from silos); German Patent No. 4,105,610, published Sep. 12, 1991 (implement for removing silage from a silo); and German Patent No. 4,013,079, published Oct. 31, 1991 (implement for removing silage from drive-in silos).

Various other patents showing devices for removing silage from storage include U.S. Pat. No. 4,618,304, issued Oct. 21, 1986 to E. Finger (silo hopper for silage unloaders); U.S. Pat. No. 6,591,971, issued Jul. 15, 2003 to D. Sheahan (silage mover for removing silage from a bunker); German Patent No. 3,938,968, published May 29, 1991 (implement for silage removal having pre-conveyors and rotary loosening tools); and German Patent No. 4,035,753, published May 14, 1992 (removal and conveying of silage from a silo independent of a tractor).

None of the above inventions and patents, taken either singly or in combination, is seen to describe the instant invention as claimed. Thus, the method and apparatus for removing animal feed from storage bags is desired.

### SUMMARY OF THE INVENTION

The method and apparatus for removing animal feed from storage bags facilitate the process of using a loader bucket to unload silage from plastic feed storage bags. The apparatus includes a front ramp, a bottom roller positioned behind the ramp, and a loading deck positioned behind the bottom roller. The apparatus also has a pivotally mounted scraper at the rear of the bottom roller. The scraper is attached to the top of a stop-member, which is mounted directly onto the loading deck. The bottom roller also includes cable-rolling portions that wind up anchored cables to move the wheel-less apparatus along the ground. Top and side auxiliary rollers disposed on the loading deck take up the remainder of the feed storage bag. The apparatus may also include two fences that run along the sides of the loading deck and along the sides of a feed storage bag, and upper and lower cutting blades for separating the different sections of the feed storage bag before it is rolled up onto the rollers.

The apparatus is used by placing it at an open end of the feed storage bag, draping the bottom plastic material of the feed storage bag over the ramp and attaching it to the bottom roller. The bottom roller rotates, pulling the bottom plastic material over the ramp and onto the bottom roller while simultaneously moving the apparatus underneath the feed storage bag rolling up the ends of the anchored cables onto the cable-rolling portions of the bottom roller. A winch for each cable may be provided behind the closed end of the bag in order to incrementally adjust the movement direction of the apparatus for feed storage bags in non-linear alignment. The movement of the apparatus under the feed storage bag and the removal of the bottom plastic part of the feed storage bag forces the animal feed (silage) to fall onto the loading deck. The animal feed is then collected into a loader bucket.

Accordingly, it is a principal object of the invention to provide an economical and efficient apparatus that facilitates the removal by loader bucket of animal feed from a feed storage bag by removing the bag from underneath the loading zone and by moving a deck underneath the animal feed.

It is another object of the invention to provide an apparatus and method for removing animal feed from storage bags that reduces the amount of animal feed wasted due to spoilage and due to mixing the feed with dirt and plastic scraps.

It is another object of the invention to provide an apparatus for removing animal feed from storage bags that provides rollers for an easy collection of the entire feed storage bag as it is unloaded.

It is a further object of the invention to provide an apparatus for removing animal feed from storage bags that optimizes the ratio of the speed of the apparatus moving towards the closed end of the bag to the speed of the plastic material take up of bottom roller.

Still another object of the invention is to provide an apparatus for removing animal feed from storage bags that can adapt to feed storage bags of different sizes and shapes.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental elevation view of an apparatus for removing animal feed from storage bags according to the invention.

FIG. 2 is a vertical section view of the ramp, roller, scraper, hinge, stop-member and loading deck of the apparatus of the present invention.

FIG. 3 is a flow chart showing steps of the method of using the apparatus to remove animal feed from a storage bag according to the present invention.

FIG. 4 is a top view of the apparatus of the present invention.

FIG. 5 is an environmental top view of the apparatus of the present invention in position for a feed storage bag.

FIG. 6 is a side view of the apparatus of FIG. 5.

FIG. 7 is an environmental side view of the apparatus of FIG. 5 in use.

FIG. 8 is a section view along lines 8-8 of FIG. 5 FIG. 9A is a perspective view of the auxiliary roller frame for an apparatus for removing animal feed from storage bags according to the present invention.

FIG. 9B is a perspective view of an alternative embodiment of side rollers and supports for the apparatus of the present invention.

FIG. 10 is a side view of the auxiliary roller frame of the apparatus of the present invention with a side roller partially broken away.

Similar reference characters denote corresponding features consistently throughout the attached drawings.

### DETAILED DESCRIPTION OF THE PREFERRED EMBODIMENTS

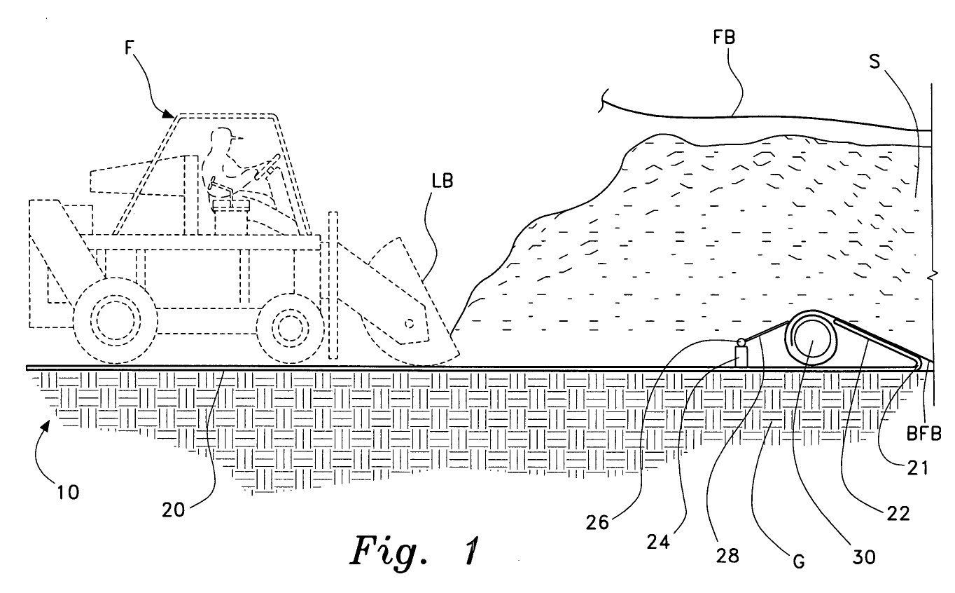

As depicted in FIG. 1, the present invention is an apparatus used to facilitate the collection of animal feed S, such as silage, from a feed storage bag FB. The apparatus provides a means for removing the animal feed from the feed storage bag FB without having mud from the ground G mix in with the animal feed S and without having the plastic material of the feed storage bag FB rip and mix in with the animal feed, and provides a means of collecting the parts of the feed storage bag FB as the feed S is removed. Removing the bottom plastic material BFB (it will be understood that the term “bottom plastic material” as used in the present application refers to that portion of the feed storage bag FB that bears against the ground when the storage bag FB contains animal feed S), which is collected onto the bottom roller 30, and pushing the animal feed S onto the large loading deck 20 allows a user of this apparatus to collect the animal feed S with a loader bucket LB without contaminating the animal feed with mud or plastic scraps.

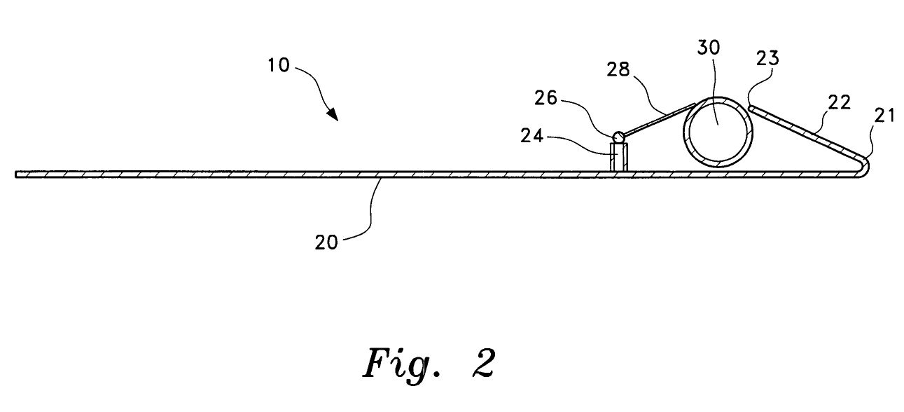

As shown in FIG. 2, the apparatus, generally designated as 10, has a loading deck 20, a ramp 22, and a bottom roller 30. The apparatus 10 also includes a scraper 28 mounted to a stop-member 24. The stop-member 24 is mounted on the loading deck 20 behind the bottom roller 30. The scraper 28 is pivotally mounted to the stop-member 24 by a hinge 26 that allows the scraper 28 to adjust as the bottom plastic material BFB of the feed storage bag FB rolls onto the bottom roller 30.

The apparatus 10 is moved underneath the bottom plastic material of the feed storage bag by pushing the ramp 22 underneath the feed storage bag FB. The bottom plastic material BFB is rolled around the bottom roller 30 after moving up the ramp 22. The leading edge 21 of the ramp 22 has an appropriate radius of curvature in order to enable the apparatus 10 to move under the feed storage bag FB without digging into the ground G or ripping the feed storage bag FB. The preferred radius of curvature for the leading edge 21 is between about ⅜ inch and 1 inch. In a field test, it was found that a radius of curvature of ¼ inch caused the apparatus to dig into the ground G and cause dirt to move up the ramp 22 between the ramp 22 and the bottom plastic material BFB and fall underneath the bottom roller 30.

The ramp forms an acute angle with the surface of the deck, preferably between about 20° to 45°, optimally about 30°. The top edge 23 of the ramp stops short of the bottom roller 30, leaving a clearance space that will accommodate the diameter of the bottom roller 30 when the full length of the feed storage bag FB is wound on the roller 30, a typical storage Bag FB being about two hundred fifty (250) feet long and eight (8) mils thick.

A potential problem is that dirt and animal feed S might also be inadvertently rolled up onto the bottom roller 30 with the bottom plastic material BFB, further increasing the thickness of the rolled material. If the clearance space is insufficient, then the bottom roller 30 will jam when the thickness of the rolled up plastic material exceeds the amount of clearance space. Too large of a clearance space may cause mechanical problems if the bottom plastic material BFB sags into the clearance space. The clearance space is preferably between about 1½ to about 3 inches, optimally about 2 inches, but may vary for bags of different lengths or material thickness.

In order to prevent such jamming of the bottom roller 30, the present invention provides a scraper 28 that is used to prevent animal feed S from sticking to the plastic storage bag FB and falling underneath the bottom roller 30. The scraper 28 is made of steel or another suitable rigid material. The scraper 28 is pivotally mounted, e.g., by a hinge 26, on a stop-member 24. The hinge 26 allows the scraper 28 to adjust as the bottom plastic material BFB is rolled up onto the bottom roller 30 during use of the apparatus 10.

The loading deck 20 is a sheet of steel or another suitable rigid material that allows for a user to easily scoop up animal feed S, such as silage, into a loader bucket LB of a front end loader, skid steer loader, or the like. The loading deck 20 and the ramp 22 also preferably are made out of a single steel sheet with one side section of the steel sheet being bent or rolled to form the ramp 22.

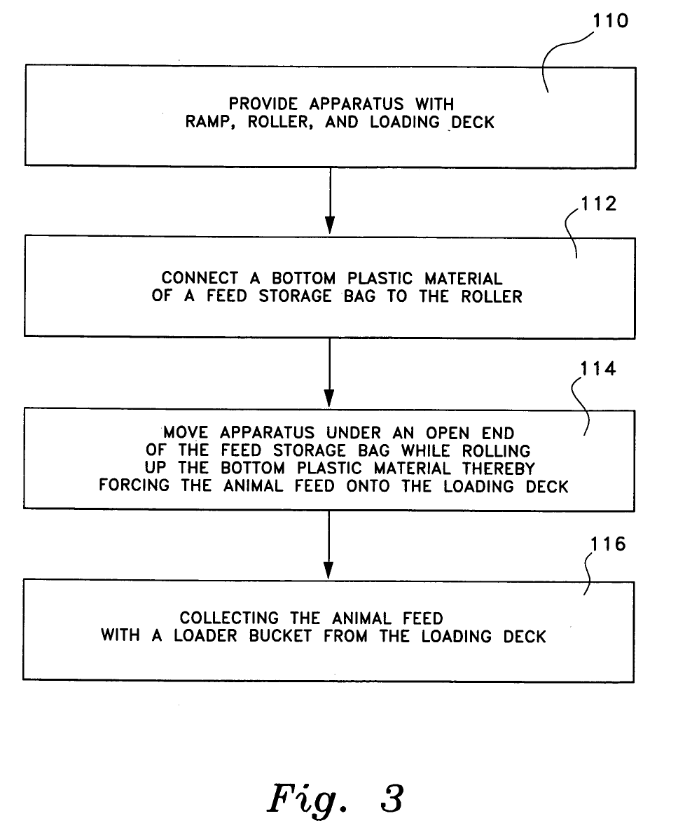

As shown in the flow chart of FIG. 3, the method of unloading silage S from a feed storage bag FB using the apparatus 10 involves the step 110 of the providing of the above-described apparatus 10, the step 112 of connecting of the bottom plastic material BFB of the feed storage bag FB to the bottom roller 30, the step 114 of moving the apparatus 10 underneath the feed storage bag FB as the bottom plastic material BFB is rolled up onto the bottom roller 30, and the step 116 of collecting the animal feed from the loading deck 20 with a loader bucket LB.

The step 110 of providing the apparatus 10 only requires the use of an apparatus 10 having at least a loading deck 20, a ramp 22 and a bottom roller 30. The step 110 may also be achieved by the use of an apparatus 10 having additional features, as described further below.

The step 112 of connecting a bottom plastic material BFB of the feed storage bag FB to the bottom roller 30 may be performed by attaching the bottom plastic material BFB to the bottom roller 30 with duct tape. It may be necessary to slit the sides of the bag FB near the opening with a knife or other cutting implement in order to attach the leading edge of the bottom plastic material BFB to the roller 30, the bag FB subsequently tearing along the sides as the apparatus 10 advances. The leading edge of the bottom plastic material BFB could also be attached by providing the bottom roller 30 with a clamping mechanism to firmly hold the leading edge of the bottom plastic material BFB. Other means may be provided for the initial attachment of the bottom plastic material BFB to the bottom roller 30.

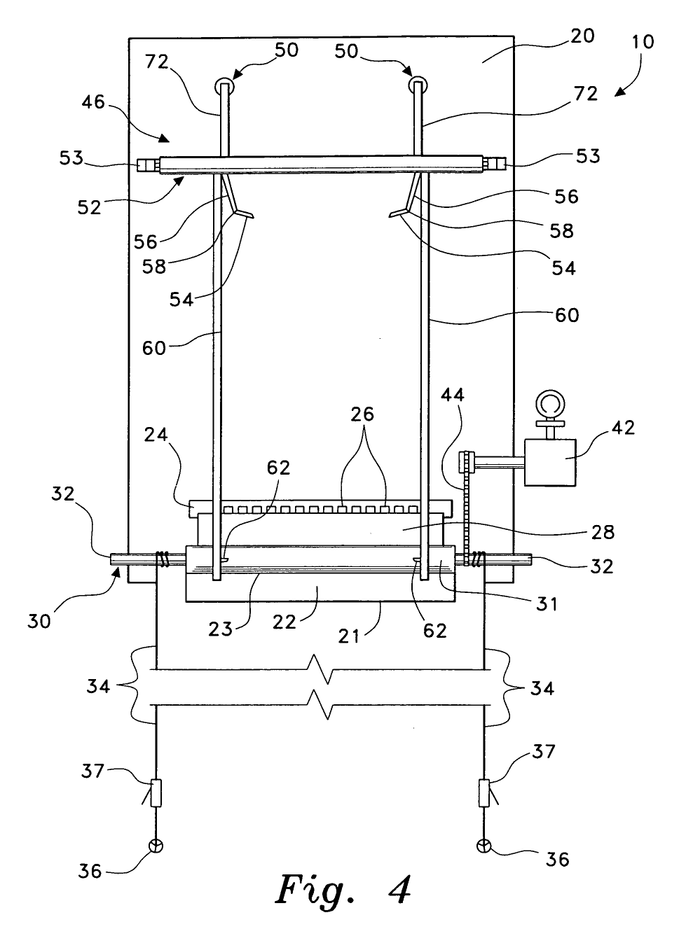

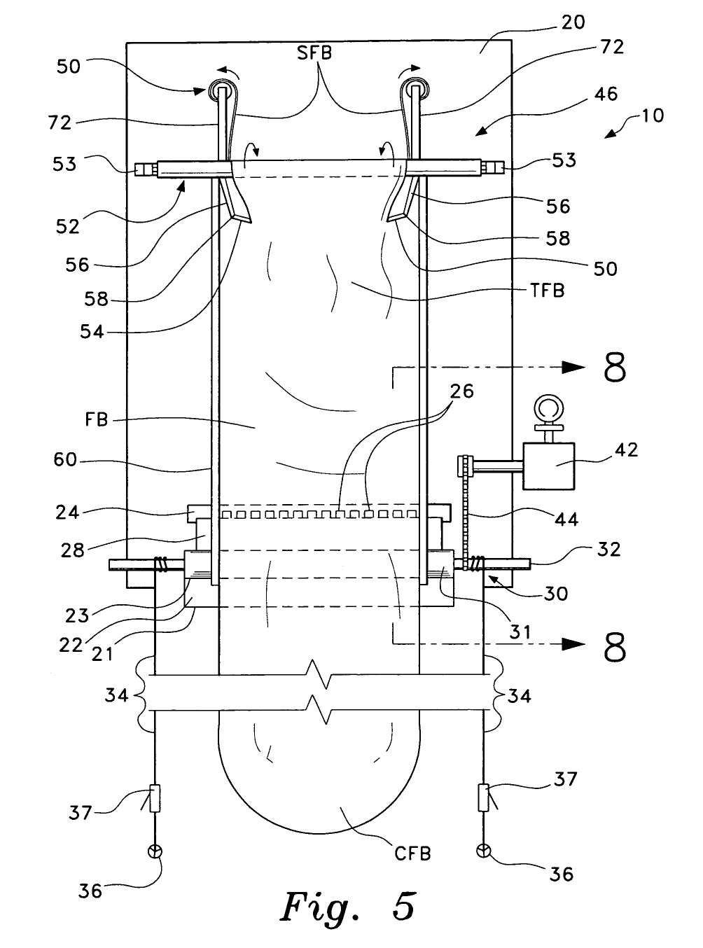

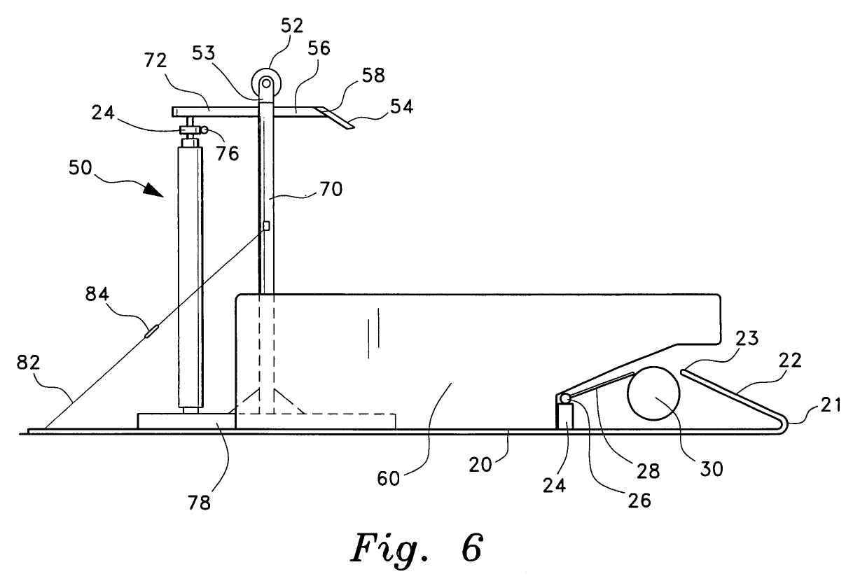

The step 114 of moving the apparatus 10 under an open end of the feed storage bag FB while rolling up the bottom plastic material BFB is preferably achieved by winding anchored cables 34 (shown in FIGS. 4 and 5) around the ends of the bottom roller 30 so that the bottom roller 30 acts as a winch pulling the apparatus along the ground G as the bottom roller 30 turns. The movement of the apparatus 10 along the ground G towards the closed end CFB of the feed storage bag FB is preferably at a slower rate than the rate on which bottom plastic material BFB is rolled up onto the bottom roller 30. This is achieved by providing cable-rolling portions 32 of the bottom roller 30, with a smaller diameter than the central plastic rolling portion 31 of the bottom roller 30. This may also be achieved by other means, including the use of pulleys. The apparatus 10 preferably pulls the bottom plastic material BFB at a speed 1.6 to 2.5 times faster than the apparatus 10 moves along the ground G. The preferred ratio of speeds is 2.0. A speed ratio of 3.2 was found to cause the bottom plastic material to rip. The faster speed prevents the bottom plastic material BFB from getting clumped up as it rolls onto the plastic rolling portion 31 of the bottom roller 30 due to the natural stretching of the bottom plastic material BFB that occurs due to the movement of the apparatus 10 underneath the feed storage bag FB. In a preferred embodiment, the ratio of the diameter of plastic rolling portion 31 to the diameter of the cable-rolling portion 32 is set equal to the desired relative ratio of the speed of the plastic pull up to the speed of the movement of the apparatus 10 along the ground G. The movement of the apparatus 10 while rolling up the bottom plastic material BFB forces the animal feed S to fall over the bottom roller 30 and onto the loading deck 20.

The step 116 of collecting the animal feed S from the loading deck 20 with a loader bucket LB involves pushing a loader bucket LB against the upper surface of the loading deck 20 to gather animal feed S into the loader bucket LB. The stop-member 24 serves to prevent the loader bucket LB from pushing against and damaging the scraper 28 or the bottom roller 30 when the loader bucket LB is being moved in to collect the animal feed S.

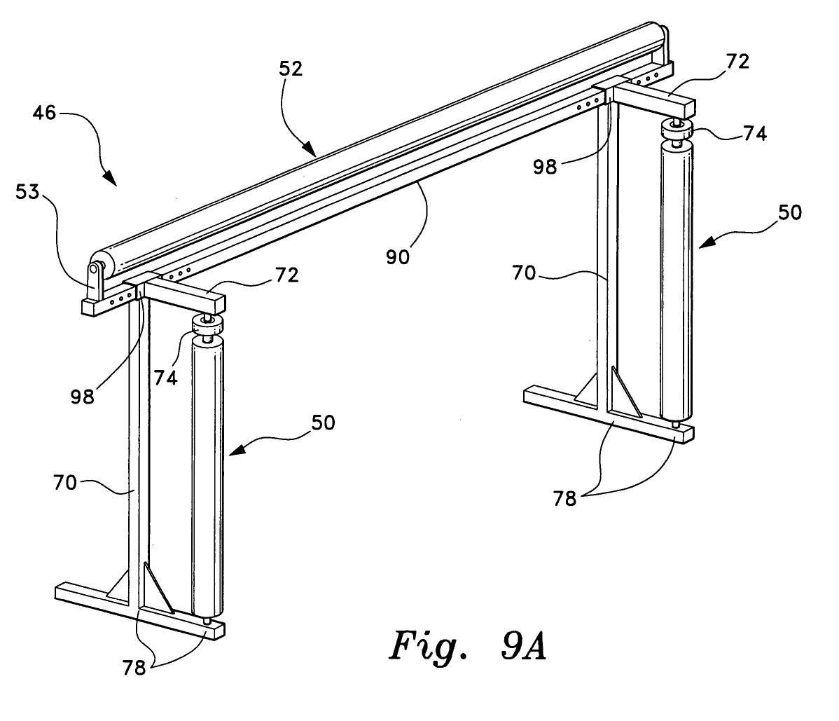

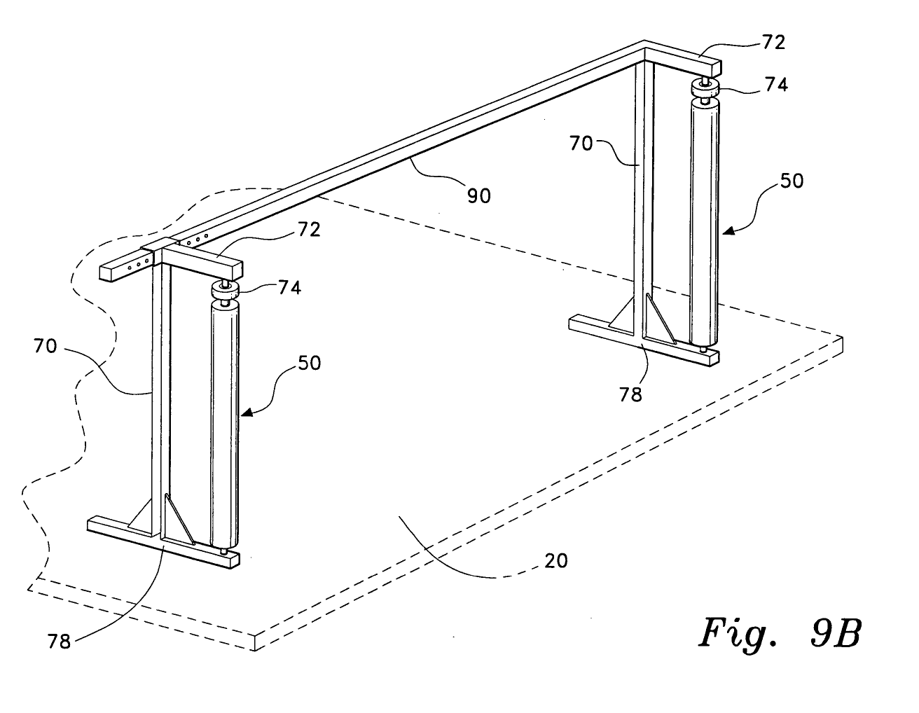

FIGS. 4 and 5 show the apparatus 10 equipped with an auxiliary roller frame 46. The auxiliary roller frame 46 sits in a floating relationship on the loading deck 20. The auxiliary roller frame 46 includes two side rollers 50 and a top roller 52. The auxiliary rollers roll up, and provide a constant pulling force to, the side plastic material SFB and the top plastic material TFB of the feed storage bag FB while the apparatus 10 is in use. The constant pull force helps to keep the animal feed S from falling to the side as it tumbles over the bottom roller 30, and also helps to ensure that snow and water easily slide off of the feed storage bag FB. The auxiliary roller frame 46 is shown in greater detail in FIG. 9A and discussed below.

Two top cutting blades 54 may also be attached to the auxiliary roller frame 46. The top cutting blades 54 cut the top plastic material TFB from the side plastic material SFB prior to rolling the top plastic material TFB onto the top roller 52 and the side plastic material SFB onto the side rollers 50. The top cutting blades 54 are attached at an angle and spaced in front of the auxiliary roller frame 46. The top cutting blades 54 may be provided with an arm 56 to space the top cutting blades 54 in front of the auxiliary roller frame 46. A cutting blade hinge 58 may also be provided to allow for the top cutting blade 56 to pivotally adjust for feed storage bags FB of different shapes and sizes. It would also be possible to perform the method of this invention without providing a top cutting means, but instead manually cutting the feed storage bag FB as the apparatus 10 moves along the length of the feed storage bag FB. This is a realistic option due to the slow pace of unloading a feed storage bag FB over the course of a winter.

Two fences 60 are attached to each side of the auxiliary roller frame 46, forming a box with the loading deck 20. The fences 60 are preferably made out of a sheet of ½ inch thick polyethylene or another suitable semi-rigid material. Each fence is preferably about twenty-four inches high and about sixty inches in length. The fences 60 each abut the stop-member 24 and overhang the bottom roller 36, extending about a foot past the bottom roller 30. The fences 60 are provided with lower cutting blades 62, which separate the bottom plastic material BFB from the remainder of the feed storage bag FB. Adjusting the fences 60 to run exactly along both sides of the feed storage bag FB will insure that both lower sides of the feed storage bag FB will be properly cut. Because each fence 60 may be attached to the sides of the auxiliary roller frame 46, the adjustment of the fences 60 may be achieved by adjusting the side roller supports 70. The adjustment mechanism of the auxiliary roller frame 46 is shown in greater detail in FIG. 9A. The lower cutting blades 62 may optionally be spring-loaded. The lower cutting blades 62 are positioned just over the bottom roller 30.

As shown in FIG. 5, the fences 60 run along the side plastic material SFB like a ski, which enables the lower cutting means to automatically cut the feed storage bag FB as the apparatus 10 is moved forward. The front edge of each fence 60 is preferably beveled in order to prevent the front edge of the fences 60 from ripping the sides of the feed storage bag FB. Other lower cutting means may be provided. It would also be possible to perform the method of this invention without providing a cutting means 62, but instead manually cutting the feed storage bag FB as the apparatus moves along the length of the feed storage bag. This is a realistic option due to the slow pace of unloading a feed storage bag FB over the course of a winter.

The bottom roller 30 is preferably powered by roller chain 44, which is connected to a conventional motor 42. This motor 42 may be of any type, including a hydraulic motor or a gas powered motor. In the preferred embodiment the roller chain 44 is a #80 roller chain.

The bottom roller 30 includes cable-rolling portions 32 on either side of main plastic-rolling portion 31. One end of each cable 34 is attached to each cable-rolling portion 32. The cable 34 rolls up onto the cable-rolling portion 32 as the bottom roller 30 is rotated by the power of the motor 42. Suitable ground anchors 36 anchor the opposite ends of the cables 34 to the ground G at a point behind the closed end CFB of the feed storage bag FB. The apparatus 10 may also be provided with a suitable backstop or other means for anchoring the cables 34 to a fixed point behind the closed end CFB of the feed storage bag FB. Each anchored cable 34 is also preferably provided with a winch 37 at a point behind the closed end CFB of the feed storage bag FB in order to allow for an incremental adjustment of the direction that the apparatus 10 is being pulled for situations where the feed storage bag FB is placed on the ground G in a non-linear arrangement.

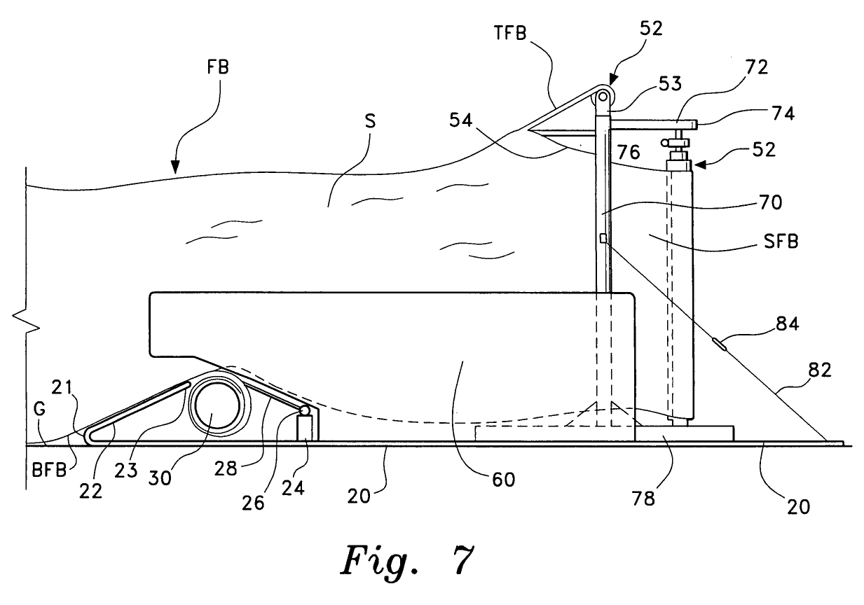

Referring to FIGS. 6 and 7, each fence 60 is attached to the inside of each side roller support 70. Each fence 60 abuts the stop-member 24, travels just above the scraper 28, hovers above the bottom roller 30, and extends about a foot past the bottom roller 30. The part of the fence 60 above the scraper 28 gives the scraper 28 enough clearance space in order to allow the scrapper 28 to adjust to give the bottom roller 30 sufficient clearance space, preferably the same amount of clearance space given between the bottom roller and the top edge 23 of the ramp 22. The positioning of each fence 60 is maintained by having a lower portion of each fence 60 abut the stop-member 24.

The auxiliary roller frame 46 may also be provided with guy wires 82 that connect each side roller support 70 to the loading dock 20. Guy wires 82 are preferably made of a nylon strap and are load binding. The guy wires may also be provided with a turnbuckle or ratcheting device 84 to adjust the length of the guy wires 82 as the positions of the side rollers 50 are adjusted. The guy wires 82 are attached at a point about the half way up the side roller supports 70. The guy wires 82 prevent the auxiliary roller frame 46 from being pulled over by the force generated by the top roller 52 and the side rollers 50, particularly the force generated by the top roller 52.

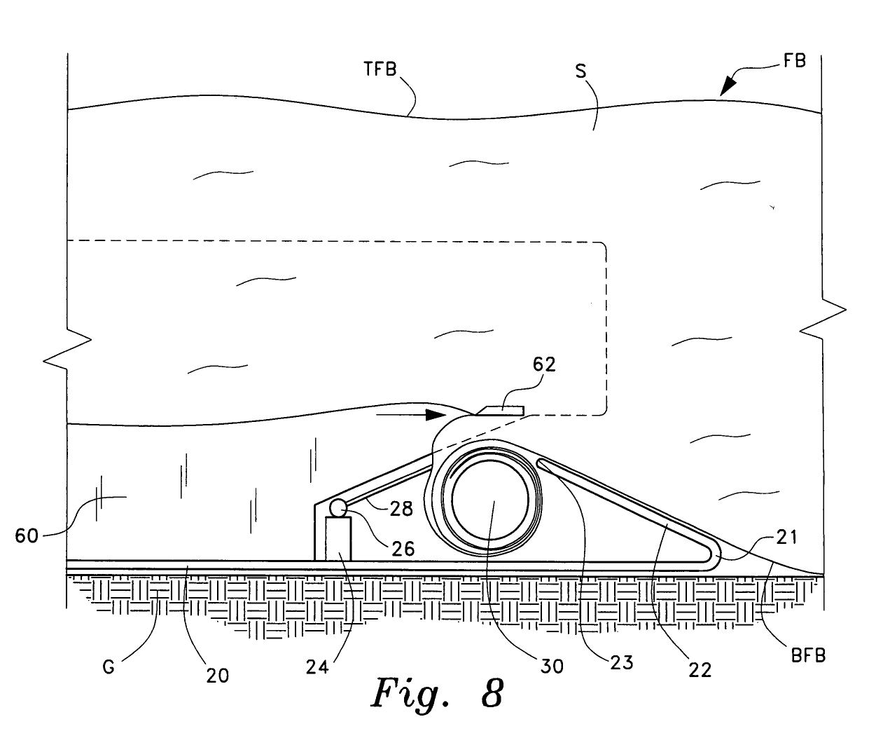

Referring to FIG. 8, the lower cutting blade 62 separates the bottom plastic material BFB from the remainder of the feed storage bag FB prior to the bottom plastic material BFB rolling onto the bottom roller 30. The bottom of the feed storage bag FB moves up off the ground G and over the ramp 20. The bottom plastic material BFB is then cut by lower cutting blade 62, passes under the scraper 28, and around the bottom roller 30. The scraper 28 prevents the animal feed S from going under the bottom roller and the animal feed S passes over the scraper 28 and onto the loading deck 20.

FIG. 9A shows a perspective view of the auxiliary roller frame 46. The auxiliary roller frame 46 includes two side support members 70, two side rollers 50, two side roller upper supports 72, a cross bar 90, two lugs or side top roller supports 53, a top roller 52, and two lower support feet 78. The frame 46 is positioned on the loading deck 20 in a floating relationship, allowing for the frame 46 to adjust for variations in bag shape and size. Each of the side support members 70, along with a side roller upper support 72 and a lower support foot 78, support a side roller 50. The cross bar 90 is attached to the top of each side support member 70. The top roller 52 is positioned above the cross bat 90 supported on its ends by two side top roller supports 53. One or both of the side support members 53 are attached to the cross bar 90 by adjustable sleeve 98 along the length of the cross bar 90 in order to adjust the frame 46 for feed storage bags FB of different dimensions. This adjustment also adjusts the positioning of the fences 60 for differently sized feed storage bags FB.

The top roller 52 and both side rollers 50 are spring-loaded to provide a constant pulling force on the top plastic material TFB and side plastic material SFB in order to keep the plastic material of the feed storage bag FB tight enough to shed water and snow and tight enough to keep the animal feed S from falling to the side as it tumbles over the bottom roller 30, even as the plastic material stretches.

FIG. 9B shows a perspective view of an alternative embodiment having two side rollers 50 and a crossbar 90, but no top roller 52. Because the apparatus 10 will only move a few feet at a time, the top plastic material TFB may be manually cut away as the apparatus 10 advances. The two side rollers 50 sit on the loading deck 20. The spacing of the two side rollers 50 is enabled by an adjustable sleeve 98 being positioned on at least one side roller 50 so that at least one side roller's position on the cross bar 90 may be adjusted. The side rollers 50 are spring loaded to keep the side plastic material SFB tight for the same reasons given above.

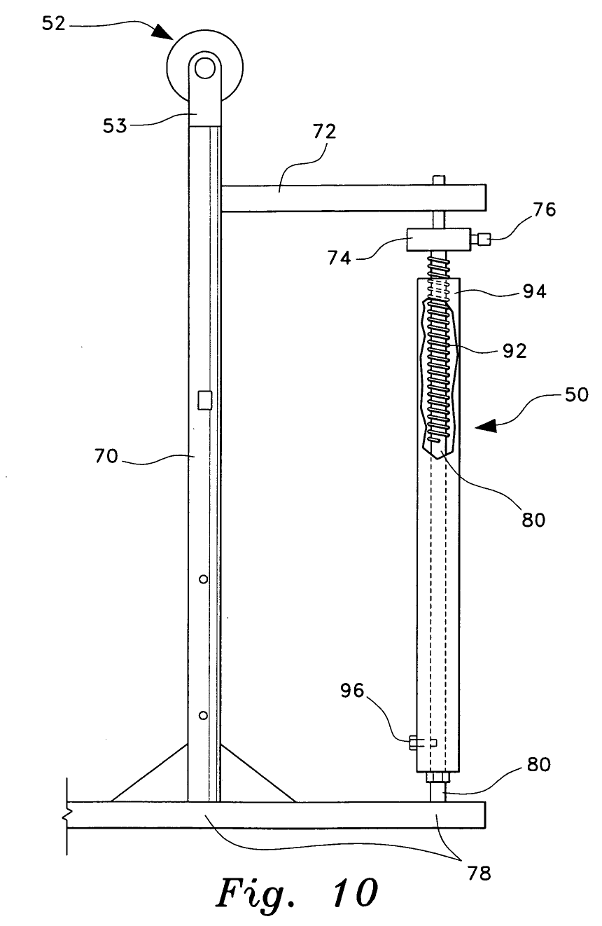

FIG. 10 shows a detailed view of a side roller 50, which is representative also of the top roller 52. The side roller 50 has an internal pipe 80, an external pipe 94, a worm gearbox 74, and a torsion spring 92 between the internal pipe 80 and the external pipe 94. One end of the torsion spring 92 is connected to the worm gearbox 74 and the other end is connected to the internal pipe 80. One end of the internal pipe 80 is mounted in the worm gearbox 74 and the other end is mounted in a close fitting bearing in the frame foot 78, allowing the internal pipe 80 to rotate with respect to the worm gear 74 and the auxiliary roller frame 46 in general. The torsion spring 92 creates a torque force causing the internal pipe 80 to rotate. The internal pipe 80 is attached to the external pipe 94, preferably by a bolt 96, so that the internal pipe 80 and the external pipe 94 rotate together. The side plastic material SFB wraps around the external pipe 94 section of the side roller 50. The worm gearbox 74 is further provided with an exterior tightening means 76 for tightening up the torque spring 92 when the side plastic material SFB begins to go limp. The exterior tightening means 76 causes the torsion spring to rewind around the interior pipe 80 as the spring 92 relaxes when the side roller 50 rotates. The top roller 52 is also provided with an internal pipe, a torsion spring, and a worm gearbox in the same relationship as the side rollers 50. The side rollers 50 and the top roller 52 preferably pull the plastic material with about fifty to about one hundred twenty-five pounds of force. This force is optionally counteracted by the fences 60 abutting the stop-member 24 and/or by the guy wires 82.

It is to be understood that the present invention is not limited to the embodiments described above, but encompasses any and all embodiments within the scope of the following claims.

I claim:

1. An apparatus for removing animal feed from a feed storage bag, comprising:
an elongated loading deck having a leading edge and a trailing edge, the deck being adapted for receiving the animal feed after removal from the storage bag;
a ramp extending upward and rearward from the leading edge of the loading deck, the ramp terminating in a top edge;
a bottom roller being positioned in rear of the ramp adjacent the top edge;
means for rotating the bottom roller, the bottom roller being adapted for rolling up a bottom portion of the storage bag; and
means for advancing the leading edge of the deck towards an open end of the storage bag, whereby the feed and the bottom portion of the bag extending up the ramp and the bottom portion of the storage bag being rolled up on the bottom roller in order to separate the feed from the storage bag and discharge the feed on the deck for pickup by a loader bucket.

2. The apparatus for removing animal feed according to claim 1, further comprising a scraper positioned adjacent said bottom roller for scraping feed from the storage bag prior to rolling the bag on said bottom roller.

3. The apparatus for removing animal feed according to claim 2, further comprising a stop-member mounted on said loading deck adjacent said bottom roller for preventing the loader bucket from impacting said bottom roller, said scraper being pivotally attached to said stop member.

4. The apparatus for removing animal feed according to claim 1, wherein said advancing means comprises a pair of cables having a first end attached to opposite ends of said bottom roller and a second end adapted for being anchored adjacent a closed end of the feed storage bag, whereby said loading deck is advanced towards the feed storage bag when said bottom roller is rotated.

5. The apparatus for removing animal feed according to claim 4, further comprising a winch attached to the second end of each of said cables.

6. The apparatus for removing animal feed according to claim 1, further comprising an auxiliary roller frame positioned on said loading deck and having two side rollers and a top roller adapted for rolling up side and top portions of the feed storage bag, respectively.

7. The apparatus for removing animal feed according to claim 6, wherein at least one of said two side rollers and said top roller is spring-loaded in order to provide a constant torque force to the feed storage bag.

8. The apparatus for removing animal feed according to claim 6, wherein said auxiliary roller frame further includes two upper cutters adapted for cutting the feed storage bag prior to the rolling up the top and side portions of the feed storage bag onto said top roller and said side rollers.

9. The apparatus for removing animal feed according to claim 1, further comprising:
a pair of parallel side fences mounted on said loading deck; and
a cutter mounted on each of the fences adapted for cutting the feed storage to define the bottom portion prior to the bottom portion being rolled onto said bottom roller.

10. The apparatus for removing animal feed according to claim 1, further comprising:
a pair of side roller support structures positioned on said loading deck;
a side roller mounted on each said side roller support structure; and
a fence attached to and extending from each said side roller support structure.

11. The apparatus for removing animal feed according to claim 10, further comprising:
a cross bar extending between said side roller support structures; and
a top roller mounted above said cross bar.

12. The apparatus for removing animal feed according to claim 1, wherein said means for rotating comprises:
a motor having a driveshaft; and
a chain and sprocket linkage between the driveshaft and said bottom roller.

13. A method for removing animal feed from a feed storage bag, comprising the steps of:
providing an apparatus including loading deck, a ramp extending from the loading deck, and a bottom roller, said ramp being positioned in front of said bottom roller, said loading deck extending behind said roller;
connecting a bottom plastic material of a feed storage bag to said bottom roller;
moving said ramp of said apparatus under an open end of said feed storage bag while rolling the bottom plastic part up onto said bottom roller, thereby forcing the animal feed onto said loading deck; and
collecting the animal feed with a loader bucket from said loading deck.

14. The method for removing animal feed according to claim 13, further comprising the step of dragging the loading deck towards and open mouth of the feed storage bag.

15. The method of removing animal feed according to claim 13, further comprising the step of cutting the bottom plastic material from the storage bag while rolling the bottom plastic material onto the bottom roller.

16. The method of removing animal feed according to claim 13, further comprising the steps of:
providing to and side cutters;
cutting the feed storage bag to define top and side bag portions.

17. The method of removing animal feed according to claim 16, further comprising the steps of:
providing top and side rollers; and
rolling up the top and side bag portions on the top and side rollers while dragging the loading deck towards the feed storage bag.
